(19) United States
(12) Patent Application Publication
(10) Pub. No.: US 2003/0014223 A1
(43) Pub. Date: Jan. 16, 2003

(54) Building design analyzer

(75) Inventors: Calvin Edward Phillips, San Jose, CA (US); John Ronald Feemster, Saratoga, CA (US)

Correspondence Address: APPLIEDVB INC., 359 SPODE WAY, SAN JOSE, CA, 95123, US

(73) Assignee: Mr. Calvin Edward Phillips

(21) Appl. No.: 10/064,629

(22) Filed: Jul. 31, 2002

(51) Int. Cl. G06F 17/50

(52) U.S. Cl. 703/1

(57) ABSTRACT

A computer software program with the process capability to do component structure stress and deflection analysis for beams, joists, rafters, shear walls, and foundations as well as determine the suitability of a structure to withstand wind and seismic forces. A program that has the process capability to determine composite weights of floors, walls, ceilings, and roofs. A software program process that does structural analysis using many different common building materials providing results that show marginal analysis compared to standard allowable parameters, provides a feature to avoid errors in the material properties selected for a structure, and is further formulated to print and/or save the analysis information in a data base file.

### CROSS REFERENCE TO RELATED APPLICATIONS

Patents for computer software are relatively new and are listed in computer accessed database lists. This listing was searched using the key words that are relevant to this claim. While there are claims that are somewhat relevant, they are based on finite element analysis. Finite element analysis is a refinement of the general type of structural analysis that applies mostly to structure shape and a given material. The subject patent is for a general structural analysis solution adequate for the use of the more common use of materials in building homes, furniture, and the like. The usefulness of this software process is in the capability to evaluate a broad number of types, sizes, and grades of materials to a structural configuration. The claimed evaluation process is structured to allow the user to determine the structural suitability for many different materials and grades of materials to meet use standards and degree of compliance to a standard with margin. Since the claimed process displays margin as a part of the structural analysis, it is implicit that this information can also be used to assist the user in economic decisions for use of materials in the evaluated structure. No other claim of the type used in the claimed process was found in a database search.

### Copyright Statement

This program and associated GUI screens were submitted for copyright protection on Jan. 5, 2000 and submitted for updating on Nov. 1, 2001.

### Background of Invention

Historically, calculations for the structural design of residential housing have been done by hand using tables from handbooks of various building organizations. This program was developed to move this process into the electronic age and greatly improve speed and accuracy of these types of calculations.

The present invention relates generally to structural analysis processes, and more particularly to an analysis process that uses a combination of material databases with a group of rigid structural element analysis equations set to standards (e.g. building codes) based on stress, deformation, size, grade of material, and loads or forces associated with parts of a structure. The present invention includes analysis program processes that may be used independently or in conjunction with structural analysis processes to more nearly give accurate input for the structural analysis of a system of structural components.

Stress and deformation analysis of loaded structures to a minimum standard is an important part in structures designed for habitation. For example, a residential home is expected to be safe for occupancy over a period of years. Loads and forces from people, furniture, appliances, types of materials used for surface coverings, and natural phenomena, such as wind and possible seismic events, are defined to a standard that should be met by the home structural design. Conventional structural analysis is commonly done with a singular material using properties obtained from handbooks or from memory to arrive at a conclusion that exceeds an acceptable standard value. Both computation errors and uneconomic selection of size or type of material occur because the values of allowable material properties which vary according to the material, use, size, grade, and location within the structural design may be chosen incorrectly or imprudently.

The consideration of alternate sizes, grades, or types of material are often not done because the task of evaluating other design solutions is time consuming and less attractive from a designer's or analysts viewpoint. It is common practice to use quickly accepted data for a few materials and loads without further thought for the practicality of a refined analysis where alternatives may well give a more attractive solution. This lack of consideration introduces a combination of potential errors in a specific structural element design from stress, deformation, marginally adequate application, significant over design, and/or overall uneconomic design.

A present solution for correcting a part of the above limitation(s) uses specific materials from a given supplier and suggests several sizes of the one material that would satisfy the standard. However, this solution is not as desirable since it limits the alternatives and does not show the marginal or nearly inadequate condition of a material selection. This results in a less-than-optimal consideration for a design solution. In addition, no user notification is given if the analysis is within a minimal margin which would be reason to evaluate another material and/or other material properties.

Natural forces from wind and seismic conditions impose overturning moments, plane shear loads at level interfaces, and other shear loads such as in the internal and external walls. Analysis of the associated structures that withstand these natural forces includes the relative mass and/or area of the structures that act on specific structural members. When several structural members are loaded simultaneously, the loads on the different members are distributed according to the relative position of the structural members one to another.

Structural analysis requires data that are used as loads or forces to be applied to a structural design. Those forces are composed of “general” accepted loads such as nominal experience associated with a number of people and movable items as well as dead weights and forces developed by natural causes obtained from wind or seismic stimulus. In present solution structural analysis programs, loads, weights, and forces are obtained from charts, publications, or a developed value. Those analysis program (s) do not include the capability to obtain dead weights or loads from natural causes as a part of their programming. The required data for an analysis in those cases must be obtained from other sources and may require other programs or documented references.

The software code of this defined system contains the processes to determine composite structural weights, natural forces from wind and seismic conditions, and the properties of many common materials used in the construction of homes. The program operating process is such that a selection of a material automatically uses the proper physical properties that are required in a structural analysis. When all the descriptive data is input and a “calculate” command is given, the structure is computed and evaluated according to a standard such as “building codes”. All structural analyses show the design margin compared to a standard allowable result (building code limits). The results are displayed for the user to evaluate the adequacy of the structure with the materials chosen. If the design margin is under a specified minimum, a prompt screen appears indicating the result might merit further consideration. If the design is below the allowable condition, the prompt screen indicates the condition as inadequate. In all structure design and wind and seismic analysis cases the design margin is indicated as a percentage of the allowable design parameters. The data can be saved, printed, or modified easily to document the design, materials, and results.

### SUMMARY OF INVENTION

This program translates the tables/handbooks through the development of data bases, equations and empirical relationships which allows for the design, design review, evaluation and optimization of structures, and permit submittals for residential structural design.

### BRIEF DESCRIPTION OF DRAWINGS

The six (6) Figures show below represent the key process flows of the program which are described in the sequences and detail description sections.

### BRIEF DESCRIPTION OF SEQUENCES

Following program installation, the user is required to provide a use sequence number which determines the program configuration and options available to the user. From the main page, the user has the choice to perform a variety of structural calculations e.g. beams, joist, foundations, and shearwall. The user can also perform seismic and wind calculations and weight of composite structures. Each of these analyses calls a specific screen. The user can save and print all calculations.

### DETAILED DESCRIPTION

This section describes the steps through each of six program flow figures describing the features of the main code blocks. Where blocks are duplicated in subsequent figures the description does not duplicate a block function in that particular flow chart.

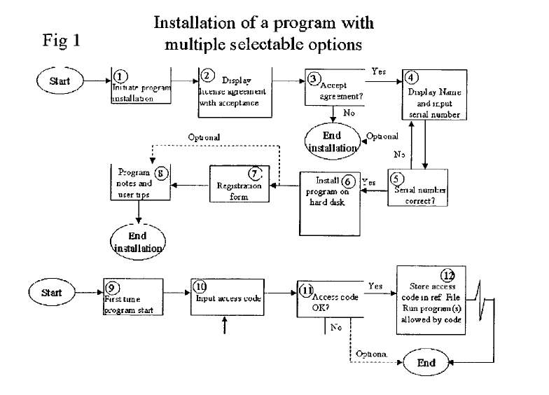

FIGS. 1 through 6 Flowchart block explanations. Note that block numbers may apply to more that one figure

FIG. 1 This is a block diagram for the part of the program that describes the process of installation and selection of an operating mode predicated on the input of an “access code”. Block 1—Initiates the program installation This block is for the process to load the program either by auto run or “setup.exe” selection

Blocks 2 & 3—Displays the licensing agreement This block is for the process that when a user agrees, the program installation continues. Otherwise, the program installation terminates.

Block 4 & 5—displays a user's name, organization and requires the input of the serial number—This block is for the process that if serial number is not correct, the program installation does not proceed.

Block 6 This is the program installation on the computer hard drive This block is the function that uses a Microsoft Installer Program

Block 7—Registration Form—This block is a process for a printable form that the user can fill in and mail to owner of the Program Licensing Agreement to assure program updates and support.

Block 8—Program Notes This block is for the process of the page telling the user/installer about the latest aspects of the program and any known bugs or problems associated with the program.

Block 9—First Time Program Start This block is the process for the first time the program is run, a program access code is required. The program has operation modes, which are configured based on the access code entered.

Block 10—Input Access Code This block is for the process of using access codes to configure all or only some functions of the program to operate. For example, a demo access code permits most analysis functions to operate but limits saving or printing most program calculations. Another separate feature is the “Material Supplier” access code. This code input allows tailoring of the materials database displayed to the user. A Material Supplier may choose a specific set of materials for display or access. The program then displays only those materials not in the database. Other access code inputs limit parts of the program functions. Specific configurations include: a. Two restricted versions, Building department and Educationalb. Unrestricted version for structuresc. Unrestricted version for structures and composite weightsd. Unrestricted version for structures, composite weights and seismic/wind analysis.

Block 11—Access Code Check This block is for the process to perform an access code check. It sets the configuration of the program for the user as well as determines if an attempt is made to tamper or input a different access code. An attempt to randomly change the access code causes an operation termination and then requires the program be reinstalled to operate.

Block 12—Runs Program per Access Code—This block portion of the program includes showing a flash screen with the copyright statement.

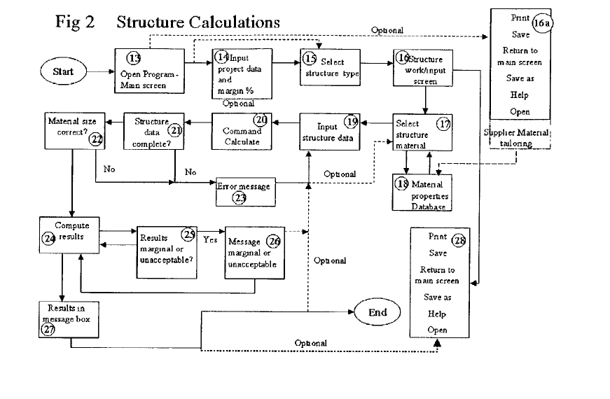

FIG. 2—This figure is a block diagram for the process functions of the program “Main Screen”. This portion of the program process is used for general project data reference and the selection of specific structural configuration types for analysis.

Block 13—Open Program Main Screen—This block part of the program opens the main screen, which is configured to accept the input of data for a specific project.

Block 14—Input Project Data & Margin This block is for the Project data input. It includes most common reference project information: Job Number, Owner name and address, assessor's parcel number (APN), phone number, the analyst responsible for the calculation, address and phone number of analyst and an analyst ID number.A separate data box provides a factor input for “margin”. This margin is an evaluation “help” program feature used in the computation process of results to give a qualification indicator of computed results with acceptable design standard limitations. A user may input a “margin” value to be used in results evaluations but the chosen value is limited by the program code to not be less than 10%.

Block 15—Select Structural analysis type This block is for the selection of the types of structural analysis which are: Beams (2 point, box beam, angle beam), Shear walls, Posts or Columns, Foundations (Spread foot, deep pier, spread foot pier), Joist and Rafters (floor, ceiling, roof) and a general framing structure. Each of these may be selected from a menu bar on the top of the main screen.

Block 16—Structure Input Screen This block shows that each screen gives a representation illustration of the subject structure with the type of data necessary to perform a structural analysis.

Block 16a—File/output related functions—This block is a set of command actions including file save, file save as, new/clear, load file, print file, print screen and close program. Each “save” function saves the project related data to a file location consistent with the computer setup. This block also contains a special tailoring capability based on the access code described in the text of block 10, the “material supplier”.

Block 17—Structure material selection—The material selection is an active X control that integrates a material database using the Microsoft Jet engine to display the key material parameters and a drop down menu of choices in the material database.

Block 18—Material properties database—This is a comma delimited database which contains the material size, grade and dimensions, basic strength of material properties including the extreme fiber stress for single and repetitive member use, allowable tension stress parallel to grain, allowable horizontal shear stress, allowable compression stress perpendicular to grain, allowable compression stress parallel to grain, modulus of elasticity.

Block 19—Input structure data—This block process consists of a series of text boxes into which the user inputs the structure definition of size and loading parameters.

Block 20—Command calculate—initiates a calculation routine for the defined structure, material, and loading conditions.

Block 21—Check Data Input—The first activity in the calculation routine is to verify that there is adequate input data. Parts of the input boxes require numbers within a specific range. When the input does not meet this requirement, the program displays an error message and returns the user to block 19. This feature assures a value for all key data has been entered.

Block 22—Check Material Selection—The next functions within the calculation routine is to check the material size chosen in block 17 against the structure defined in block 19. When the chosen material size is not correct, an error message is generated indicating the error. When the message is cleared, the user is returned to block 19.

Block 23—Error Messages—As indicated in blocks 21 and 22, when errors are detected in the input via these processes, error messages are generated explaining to the user what more specifically is needed to proceed.

Block 24—Compute results—This block contains the program code that computes the resultant stresses and deformation and compares these values to the allowable values given by the material database and limitations defined by building standards.

Block 25—Results percent of standard limitations, marginal percentage, or unacceptable—A later part of the program calculation code compares the allowable stresses and deformation against the calculated stresses and deflection factored with a margin defined by a building standard.

Block 26—Display message when results are marginal or unacceptable—When the calculated structure stresses and/or deflection compute to be between a standard limit and the chosen margin, a message is imposed on the screen indicating the condition. When the computation would indicate the results are below the standard, a message is imposed on the screen indicating an unacceptable condition. Any message must be acknowledged before further operation can be proceed. Any computed result beyond the margin conditions avoids a “notifying message”.

Block 27—Display results on screen—The calculation input and output values together with the margin of stress and deflection are displayed on a scrollable screen on the structure screen. Should the margin be especially large, the user may return to the input boxes and modify the parameters to achieve a more attractive computed solution.

Block 28—File/output related functions—This set of actions include file save, file save as, new/clear, load file, print results, print screen and close screen.

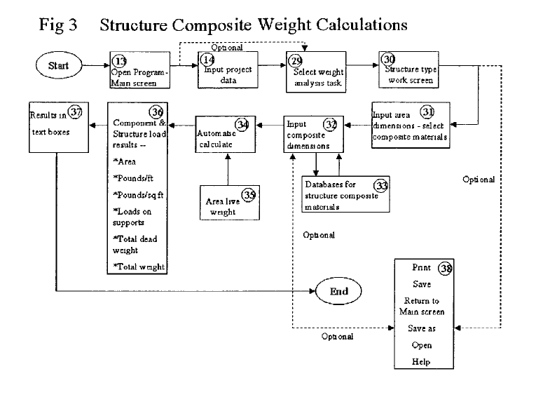

FIG. 3—This figure is a block diagram describing the process functions of the program “Composite Weight Calculations”. This portion of the program process is used for developing the weight of walls, floors, ceilings, and roof using “built-up” compositions of each. Data for the parts of each structure are selected with details of thickness or a particular factor in the build-up contribution to the overall weight. The user obtains this “weight analysis” part of the program beginning with blocks 13 and 14 given in FIG. 2.

Block 29—Select weight analysis (Dead load calculation) The process is selected from the main screen tool bar. The function is to determine the approximate total weight, weight per lineal unit, and weight per unit area of composite structures. A composite weight analysis can be calculated for ceilings, floors, roofs, walls and foundations. Each of these structure types is selected from a tool bar located on the work screen.

Block 30—Weight analysis work screen—This analysis work screen contains a simplified line representation of a house, which emphasizes a specific structure type chosen for analysis. A generalized figure composite structure is shown for reference, along with a series of data boxes for information peculiar to each composite part that defines the structure.

Block 31—Input size of composite area and select composite materials The overall size of the composite section of the wall, floor, etc., is entered in screen boxes defining the composite section area. The user then selects each material part of the composite by selecting a material type from a drop down window for each main part of a structure. An example of such materials is: stucco exterior, plywood, 2×4 wall framing, insulation, sheet rock, and the like.

Block 32—Thickness/dimensions of the composite materials—Each of the composite structure materials has an associated text boxes for the input of a thickness or feature of the composite.

Block 33—Composite materials database—Each material that can be chosen has a database providing the density per unit input material characteristic used.

Block 34—Command calculate—initiates the calculation routine the results of which computes the incremental weight contribution of each composite material and the overall weight for the defined structure as well as the weight per square unit area and weight per unit length.

Block 35—Live weight added load—At the users option, a text box is available to add a live load factor to the computation.

Block 36—Component and structure load results The computation results show the structure OLE_LINK1 area, load per unit length, load per unit area, loads on the supports, and total dead weight of the composite structureOLE_LINK1. When the live weight box has input data, that factor is added to the dead weight in the computed results.

Block 37—Display results on screen—The computed results of the area, load per unit area, load per unit length, loads on the supports, total dead weight and total structure weight are displayed on a scrollable section on the weight analysis screen. At the users option, the materials, factors, and overall dimensions may be altered to obtain a different computed result as may be appropriate for the intended end use analysis.

Block 38—File/output related functions—This set of actions include file save, file save as, new/clear, load file, print results, print screen and close screen.

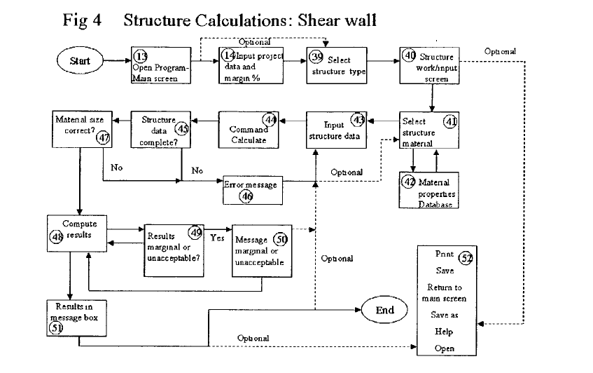

FIG. 4—This figure is a block diagram describing the process functions of the program “Shear Wall Screen”. This portion of the program process is used for analysis of a shear wall structure. The screen is configured to allow selection of different materials, nailing schedules, uniform loads and point loads for a specific shear wall structural configuration type of analysis. The figure shows the nominal program open screen (block 13 & 14) and the selection of a shear wall structural analysis.

Block 39—Select Shear Wall structure type—This block is the selection of a shear wall structure analysis from the main screen.

Block 40—Shear wall work/input screen—This screen has a reference representation of a shear wall showing the nominal applied loads and the nailing field. The screen shows a material and nailing field, which interfaces with the shear wall material properties database.

Block 41—Select shear wall material—In this block function, the user selects a specific shear wall face material grade, thickness and nailing configuration. This material control selection table interfaces with structural data based on panel material, material grade, thickness, nail size, edge nailing schedule, and field nailing schedule. The table shows the allowable shear stress in load per unit length (currently pounds per foot) for horizontal face material diaphragms.

Block 42—Shear wall material/configuration database—This database contains the detail structural parameter information related to the display in the shear wall material table in block 41

Block 43—Input shear wall data The shear wall screen has a series of text boxes for user inputs to define the shear wall structure size and loading conditions.

Block 44—Command calculate—initiates the calculation part of this analysis routine

Block 45—Check Data Input—A part of the calculation routine is to verify that all text boxes contain input data. Some text boxes are programmed to have range limitations. When a data input is outside the limitations, an error message displays on the screen. When the message is acknowledged, the user is returned to block 43 for corrective input data. Computation does not proceed with inadequate data.

Block 46—Error Messages—when errors are detected in the data inputs, the program is structured to stop a computation process and show an error message on the screen. Each message has a brief explanation of the cause and indicates a corrective action.

Block 47—Check Material Selection Another part of the calculation routine checks the material size chosen in block 41 against the structure defined in block 43. When the chosen material size is incompatible, an error message displayed and process is returned to block 43.

Block 48—Compute results—This block has the program code that computes the structure analysis results of stress and deformation. The results are compared with building standards using the “margin” parameters as defined in blocks 41 & 42.

Block 49—Results marginal or unacceptable—This part of the program performs the same function for this structure evaluation as defined in block 24.

Block 50 Display message when results are marginal or unacceptable—When the calculated structure stresses and/or deflection computes to be between a standard limit and the chosen margin, a message is imposed on the screen indicating the condition. When the computation would indicate the results are below the standard, a message is imposed on the screen indicating an unacceptable condition. Any message must be acknowledged before further operation can proceed. Any computed result above the margin conditions avoids a “notifying message”.

Block 51—Display results on screen—The calculation input and output values together with the margin of stress and deflection are displayed on a scrollable screen on the structure screen. Should the margin be especially large, the user may return to the input boxes and modify the parameters to achieve a more attractive computed solution.

Block 52—File/output related functions—This set of actions include file save, file save as, new/clear, load file, results print, print screen and screen close.

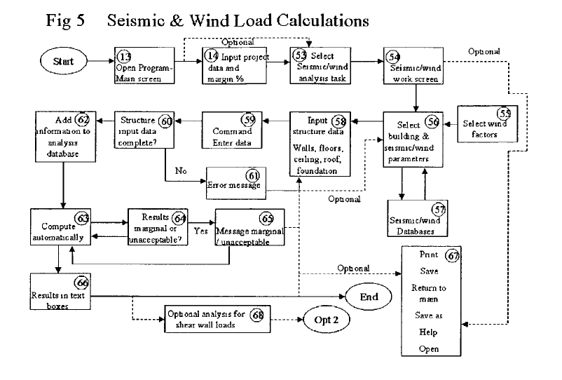

FIG. 5—This figure is a block diagram describing the process functions of the program “Seismic and Wind Load Calculations Screen”. This portion of the program process is used for analysis of a structure for the effects of seismic and wind forces. The screen is configured to allow selection of different parts of an overall structure for each of the major sections i.e. floors, walls, roof, ceiling, and foundation. As each major structural part is selected for definition, an illustrative figure of the structural part is displayed as a reference to aid in the input of descriptive data. The figure shows the normal program open screen (block 13 & 14) and the selection of seismic and wind analysis.

Block 53—Select seismic/wind analysis task—This block is the selection of a seismic/wind structure analysis from the main screen.

Block 54—Seismic/wind work screen—This screen displays a three-dimensional line representation of a structure, programmed to change based on how many stories to evaluate. This program code currently accepts up to 3 stories. Each main structure part such as exterior walls, interior walls, ceilings, floors and roof are shown in the illustration. The screen has seven sections to further define the structure to be analyzed. These are: (1) Check boxes for a simplified or complex analysis where the soil conditions are known or not known. (2) The number of stories. (3) The type of material used in the construction (wood, steel, other) and the complexity of the floor plan. (4) The basic seismic type of seismic fault/zones. (5) A database generation operation to establish a set of building components (floor, walls, ceilings, roof) in a database based on floor plans and stories of the structure to be analyzed. In this section the user inputs data for each story with dimensions and weights per unit area for all the appropriate walls, floors, ceilings, foundations, and roof. The database inputs are displayed in a scrollable table for review or modification as the user may wish. (6) A set of controls for manipulation of the data in the database (delete, add, modify records). (7) A control for the establishment of wind parameters such as exposure and maximum expected wind velocity. The computed results are shown in the lower part of the work screen. The display shows computed potential for the structure to sustain the seismic and wind shear and overturning moments.

Block 55—Select wind factors This block opens a sub screen for the input of the wind factors of structure exposure and the maximum wind velocity.

Block 56—Select building and seismic parameters This block is the function of choosing the building and seismic parameters for the data described in block 54.

Block 57—Seismic/wind database This block is for the incorporation of different analysis equations and data based on the type of seismic analysis (simplified or complex) and the wind parameters chosen for the analysis.

Block 58—Input structure data This block is for the function of developing the descriptive structure database as described in block 54 (5). This input data is used to build an organized database for computation of seismic and wind loads and moments.

Block 59—Command Enter Data—This block function is a command function in the control section described in block 54 (6) which transfers the data from the input text boxes into the structure database.

Block 60—Structure Input data complete This block function is to verify that each text box contains data that is consistent with database definitions. When the input data is incompatible the program displays an error message and returns the user to the database entry text boxes for proper input.

Block 61—Error Messages—when errors are detected in the data inputs, the program is structured to stop a computation process and show an error message on the screen. Each message has a brief explanation of the cause and indicates a corrective action.

Block 62—Add information to analysis database This block function is the addition of input data into the database.

Block 63—Compute automatically This block function is the automatic computation of loads based on the entry of the last data record.

Block 64—Display message when results are marginal or unacceptable—When the calculated structure stresses and/or deflection compute to be between a standard limit and the chosen margin, a message is imposed on the screen indicating the condition. When the computation would indicate the results are below the standard, a message is imposed on the screen indicating an unacceptable condition, any message must be acknowledged before further operation can be proceed. Any computed result beyond the margin conditions avoids a “notifying message”.

Block 65—Message marginal or unacceptable This block function is the display of a massage when the computed conditions, with margin, are near or below minimum acceptable values. The program displays no message when the results exceed the minimum acceptable value plus margin.

Block 66—Results in test boxes—Results text boxes which show the seismic and wind shear and overturning moments and associated margins

Block 67—File/output related functions—This set of actions include save, save as, new/clear, load file, print, print screen and close.

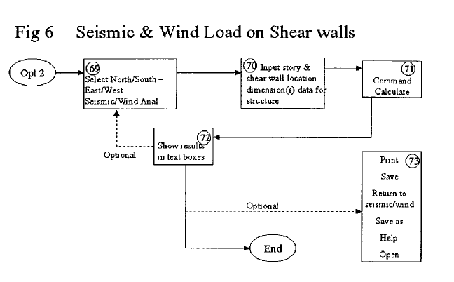

FIG. 6—This figure is a block diagram describing the process functions of the program “Seismic and Wind Loads on Shear walls Screen”. This portion of the program process is used for computing the distribution of seismic and/or wind loads on the structure shear walls.

Block 68—Optional analysis for shear wall loads—This block function is an option screen to evaluate the structure shear walls for up to 4 shear walls per story. This function uses the loads computed in Block 66 as the total load for the shear walls in a story. The function performs this computation for both wind and seismic conditions.

Block 69—Select North/South East/West Seismic/Wind analysis This block function is for the selection of the load direction for either a wind or seismic load on a shear wall.

Block 70—Input story and shear wall location dimension(s) for structure—This block function is for the text box input of the shear wall dimensional locations in each story.

Block 71—Command calculate This block function is for the computation of the loads imposed on the shear walls predicated on the shear wall location data.

Block 72—Display results on screen in text boxes—This block function is the computation display for the shear wall loads.

Block 73—File/output related functions—This block function is the set of command actions to file save, file save as, new/clear, load file, print results, print screen and screen close.

Program Listing Deposit

the program source code and GUI screens were submitted for copyright prot

What is claimed is:

1. A System for analyzing a structure having a rigid element in which:
a data input of a material used in a structure is selected from a database of multiple materials and grades each of which contains necessary physical properties to evaluate the adequacy of a structure to withstand the loads input for a structure made of the material;
a process wherein selected material physical data is automatically applied to equations which are set to compute acceptance a standard method and value;
a process wherein a computed result is compared to a minimum acceptable standard set value in such a way to indicate the selected material/structure configuration as acceptable, marginal, or unacceptable by a percentage of the minimum set value;
a process in which if a computed result is unacceptable, below the standard value, or marginal, within a determined percentage of minimum standard value,
a message screen is displayed to the user for acknowledgement before proceeding to completion of the analysis;
a process wherein a structural computation may be saved as a data file where it may be loaded at a later time such that all the data including the structural material and grade are input into the computation form and be subject to modification of all parameters as a user may wish for a modified recalculation.

2. A Computer program system wherein a building structure composed of walls, floors, foundations, ceilings, and/or roofs are defined in a database along with seismic and wind parameters such that:
a process in which the complete structural is evaluated for its potential to withstand a set standard seismic condition;
a process in which the complete structure is evaluated for it potential to withstand a set standard wind force condition;
a process in which the computed results of the defined structure physical data is automatically applied to seismic and wind equations which are set to a standard acceptance value;
a process in which the computed result of the defined structure is compared to a minimum acceptable set standard value in such a way to indicate the selected configuration is acceptable, marginal, or unacceptable by a percentage of the minimum acceptable value;
a process in which if the computed result of the defined structure is unacceptable, below a set value, or marginal, within determined percentage of a minimum set value, a message screen is displayed to the user for acknowledgement before proceeding to completion of the analysis;
a process in which the computed seismic and wind force results are subject to further separate analysis such as the loads on a support configuration (such as shear walls and foundations);
a process in which the data base of the defined structure computation may be saved as a data file where it may be loaded at a later time such that all the data including the seismic and wind parameters are input into the computation form and be subject to modification of all parameters as a user may wish for a modified recalculation.

3. A system, wherein the building structure composite details of walls, floors, foundations, ceilings, and/or roofs are defined in terms of various nominal layers and area such that:
a process in which a composite structural member is evaluated for weight per unit area, load per lateral measurement, total weight, and load on structures where only ends are employed;
a process in which a defined composite structure computation may be saved as a data file where it may be loaded at a later time such that all the data of the composite structure member are input into a computation form and be subject to modification of all parameters as a user may wish for a modified recalculation.

4. A system, wherein the programming computer code structure contains a plurality of separate operating programs such that use of selected access codes allows:
a process in which the operation of any one or a combination of the separate operating programs;
a process in which the definition of general description data made on a general or main screen is included as a part of each separate operating program;
a process in which the operation of any one or a combination of the separate operating programs may be tied together when the function of one provides data for another;
a process in which input of general control data that is used by the separate programs for evaluation of computed results;
a process in which input of a selected set of data base materials may be made from a larger material database permitting only the selected material database items to be used by the separate programs for evaluation of computed results;
a process in which the defined description may be saved as a data file where it may be loaded at a later time such that all the data of definition are input into the definition form and is subject to modification of all data as a user may wish.
